(19) United States
(12) Patent Application Publication
(10) Pub. No.: US 2005/0149364 A1
(43) Pub. Date: Jul. 7, 2005

(54) Multifunction telemedicine software with integrated electronic medical record

(76) Inventor: Mark P. Ombrellaro, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/061,490

(22) Filed: Feb. 17, 2005

Related U.S. Application Data
(63) Continuation-in-part of application No. 10/703,706, filed on Nov. 7, 2003.
Application No. 10/703,706 is a continuation-in-part of application No. 10/274,569, filed on Oct. 18, 2002, now Pat. No. 6,726,638.
Application No. 10/274,569 is a continuation-in-part of application No. 09/685,327, filed on Oct. 6, 2000, now Pat. No. 6,491,649.

(51) Int. Cl. G06F 17/60

(52) U.S. Cl. 705/3

(57) ABSTRACT

A teleconferencing system is disclosed that enables patient and physician teleconferencing stations (100) to communicate over a global network (104), wherein the teleconferencing stations include access to a database of electronic medical records (110). The system includes means for instant text messaging (130), audio/video conferencing (142), and secure e-mail exchange (146). The patient and physician have differential access to the electronic medical records, such that the electronic medical records can be updated. The physician station includes means for capturing image data received from the patient station and storing the captured image data into a medical record. In the preferred embodiment the system is able to teleconference more than two stations at a time. In the preferred embodiment, the physician station includes means for entering a prescription (310) and for entering hospital orders (304).

### CROSS-REFERENCE TO RELATED APPLICATION

This application is a continuation-in-part of U.S. patent application Ser. No. 10/703,706, filed Nov. 7, 2003, which is a continuation-in-part of U.S. patent application Ser. No. 10/274,569, filed Oct. 18, 2002 (now U.S. Pat. No. 6,726,638), which is a continuation-in-part of U.S. patent application Ser. No. 09/685,327, filed Oct. 6, 2000 (now U.S. Pat. No. 6,491,649), priority from the filing dates of which is hereby claimed under 35 U.S.C. § 120 and the disclosures of which are hereby expressly incorporated by reference.

### FIELD OF THE INVENTION

The present invention is in the field of teleconferencing systems and, in particular, to teleconferencing systems particularly suitable for use in the medical field.

### BACKGROUND OF THE INVENTION

Healthcare is a multibillion-dollar worldwide industry. In 2002, annual healthcare expenditures averaged 10% of the Gross National Product (GNP) for the European countries and Canada, while averaging over 14% of GNP for the United States. Even though the world population and life expectancies are increasing, it is unlikely that healthcare expenditures beyond current levels would be sustainable for the long term. In order to accommodate the healthcare needs of an aging and growing population on a fixed budget, countries will need to use healthcare dollars more efficiently. The predominant method of cost control in the healthcare industry has been to reduce payments to healthcare providers for services rendered. Increasing fixed business costs in the face of declining reimbursement have led to an overall decline in both the number of physicians and hospitals. The net effect is actually counterproductive in the long term as reduced numbers of care providers reduces access to healthcare for the general population. In an effort to provide an efficient and cost-effective means for exchanging medical information between physicians and patients, as well as improve access to healthcare, a novel online patient-provider communications software system has been developed. The software platform, described in detail below, constitutes a continuation-in-part patent application based on U.S. Pat. No. 6,491,649.

During the 1980s, in an effort to overcome physician shortages in rural communities, the idea of using communications and computer systems for exchanging medical information between specialist physicians and patients separated by great distances prompted the development of “telemedicine.” With the advent of the Internet and inexpensive audio and video communications systems, the scope of telemedicine continues to evolve. Many physicians currently use e-mail to correspond with patients while many patients use the Internet to seek out general medical information. Telemedicine systems, in their current form however, are limited by their inability to allow for the adequate performance of a physical examination.

Medical practice is a very unique type of personal service. A sick patient interacts with a unique skilled professional with the expectation of improving his or her health condition or alleviating suffering. The underlying physician-patient encounter is in actuality a complex data-gathering interaction that is processed by the physician, and an optimal diagnosis and treatment plan is determined. The input data from the physician-patient encounter comes from a variety of sources, including the physical examination of the patient, laboratory tests, and radiological imaging studies. The most important source of input information is the actual physical examination of the patient. The physical examination generally includes the transfer of personal historical information from the patient to the physician, a review of the patient's current medications, and a direct visual and manual examination of the patient's body by the physician. An expertly performed history and physical examination will yield a correct diagnosis with approximately 90% accuracy. In most circumstances, the laboratory and radiological imaging data provides confirmation of the diagnosis as well as adjunctive detail regarding the patient's condition.

In the general sense, the physician functions as a computer by collecting all of the available input data from the various sources, processing that information with respect to the physician's personal knowledge or reference base, establishing a list of likely diagnostic possibilities based on the input information, and then recommending a plan of treatment that is expected to improve the patient's health condition. A portion of the data required to make an accurate medical diagnosis can be exchanged among the patient, laboratory, radiology, and physician using a variety of communications methods without the need for direct face-to-face contact between the communicating entities. While the current communications revolution has allowed for the exchange of historical information, laboratory data, telemetry, and radiological studies via telephone, pager, fax, e-mail, and video, the direct manual examination of the patient's body by the physician has currently not been amenable to data collection via remote means. Under the parent patent application (U.S. Pat. No. 6,491,649 and subsequent continuation-in-part applications), a device for the remote physical examination of a patient's body and transfer of that physical data to a physician in another location is described.

Described herein is a software application that allows for the real-time exchange and storage of medical information, including all aspects of a physical examination. These components include historical information as well as real-time data gathered from a variety of sources including audio, video, single-frame still photo images, manually- and automatically-generated text data, and analog and digital format tactile sensory information. The software platform, described in detail below, constitutes a continuation in part patent application based on U.S. Pat. No. 6,491,649.

### SUMMARY OF THE INVENTION

A teleconferencing system that is particularly suited to use in the medical field is disclosed wherein teleconferencing stations connected to a network, preferably a global computer network exchange information. The teleconferencing system allows two or more users located at different locations to communicate securely, and preferably includes means for communicating via instant text messaging, real-time full duplex audio, and real-time video display.

In a preferred embodiment, the teleconferencing system includes a first teleconferencing station having a first digital camera and a second teleconferencing station located remotely from the first teleconferencing system. The second teleconferencing station receives image data from the first digital camera over the network. An electronic medical records database is accessible to one or both of the stations over the network, and at least one of the teleconferencing stations is equipped to selectively save image data from the digital directly into a medical record.

In an embodiment of the invention, the second station also includes a digital camera, and both digital cameras include microphones, so that the first and second stations can exchange real-time audio and video data.

In an embodiment of the invention, the medical records in the electronic medical records database include fields for entering medical history data, medical examination notes including audio data, demographic, and insurance information.

In the preferred embodiment, all data exchanged between the first and second teleconferencing stations is compressed and encrypted before transmission.

In an embodiment of the invention, the second teleconferencing station further comprises a template for recording a medication prescriptions and the medication prescriptions information may be saved into a medical record.

In an embodiment of the invention, the system includes an independent encrypted e-mail system such that encrypted e-mail messages can be sent between the first teleconferencing station and the second teleconferencing station over the network.

In an embodiment of the invention more than two teleconferencing stations may simultaneously teleconference, exchanging video, textual and audio data.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram of a medical conferencing system, according to the present invention;

FIG. 2 shows the medical conferencing system diagrammed in FIG. 1, wherein the peripheral devices include a hand control unit and a patient examination module for the exchange of tactile data;

FIG. 3 shows the home screen that is displayed on the user's monitor after logging into the medical conferencing system diagrammed in FIG. 1;

FIG. 4 shows an invitation window for initiating a conference between two or more users of the medical conferencing system diagrammed in FIG. 1;

FIG. 5 shows the tabbed medical records window for the medical conferencing system diagrammed in FIG. 1, with the patient information tab selected;

FIG. 6 shows the tabbed medical records window for the medical conferencing system diagrammed in FIG. 1, with the patient history tab selected;

FIG. 7 shows the tabbed medical records window for the medical conferencing system diagrammed in FIG. 1, with the review of systems tab selected;

FIG. 8 shows the tabbed medical records window for the medical conferencing system diagrammed in FIG. 1, with the search tab selected;

FIG. 9 shows the tabbed medical records window for the medical conferencing system diagrammed in FIG. 1, with the examination notes tab selected;

FIG. 10 shows the tabbed medical records window for the medical conferencing system diagrammed in FIG. 1, with the exam history tab selected;

FIG. 11 shows the e-mail window for the medical conferencing system diagrammed in FIG. 1;

FIG. 12 shows the prescription pad window for the medical conferencing system diagrammed in FIG. 1; and

FIG. 13 shows the orders window for the medical conferencing system diagrammed in FIG. 1.

### DETAILED DESCRIPTION OF THE PREFERRED EMBODIMENT

In a preferred embodiment of the present invention, described below, an integrated online patient-provider communication and electronic medical record system is provided that enables the exchange of medical and related information between healthcare stakeholders in a readily accessible, secure, and efficient fashion. The present system is suitable for exchanging medical information between two users or between and among three or more users. Specific examples showing benefits of providing functionality for more than two users are discussed throughout the disclosure. For the purposes of illustration herein, one user will be referred to herein as the “patient” and a second user will be referred to as the “physician.” However, the system provides for the exchange of information in other contexts—for example, for the exchange of information between multiple healthcare providers or for jointly providing medical care. The disclosed system may also be utilized for the exchange of information among multiple parties in other business contexts, such as business-to-business communications—for example, in business negotiations, joint venture endeavors, and in any situation where simultaneous audio, visual, and textual communications between remotely located parties is desired.

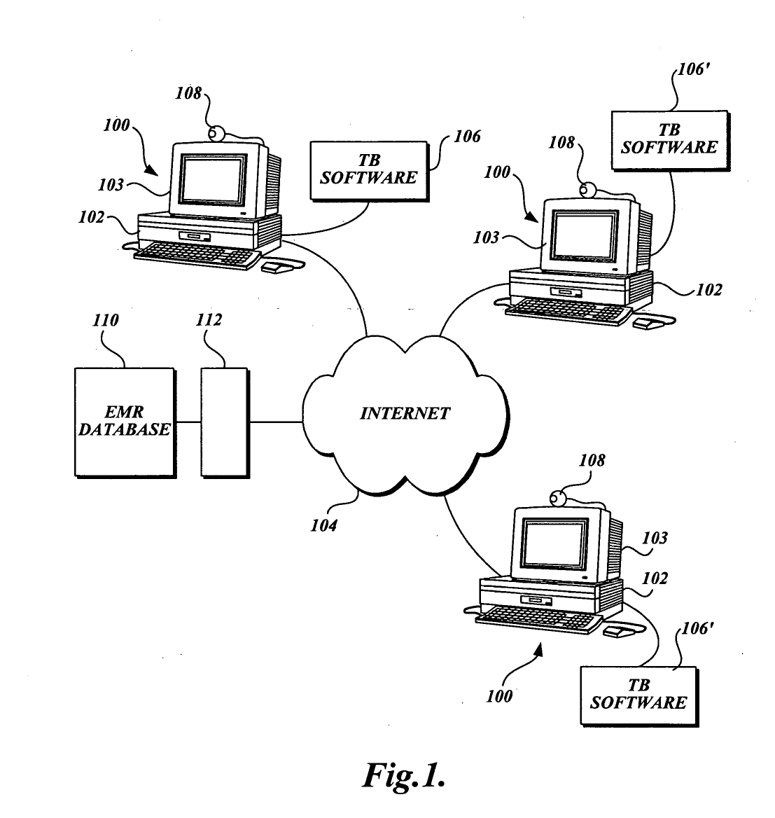

Referring now to FIG. 1, each user in the preferred embodiment will utilize a teleconferencing station 100 (three shown) that includes a computer 102 with a monitor 103, access to a network, preferably a global network such as the Internet 104, a physician software system 106 or patient software system 106′ described herein, and peripheral devices 108 to take advantage of various aspects of the software system's functionality. In the preferred embodiment of the present invention, there is a differential functionality between the physician software 106 and the patient software 106′, as discussed in more detail below.

The computers 102 may be any type of information processing device, either freestanding or a modular component, and suitably equipped to run the application software 106, 106′. Each computer may be, for example, a desktop personal computer, a laptop computer, a personal digital assistant, or any other type of processing system, including systems using advanced and/or near-term technology such as a smart chip, a bioprocessor, a nanocomputer or nanoprocessor, or processing system. In the currently preferred embodiment, the computer 102 is a personal computer that does not need to be dedicated to the present application, either a laptop or a desktop computer. Internet access may be accomplished though any suitable connection systems including, for example, dial-up, DSL, high-speed digital network, LAN, WAN, WI-FI, cellular telephone, laser light transmission systems, satellite systems, infrared carrier systems, or nuclear- or bioparticle-powered information transmission systems. Peripheral devices 108 required to allow maximal functionality include a Webcam and a microphone for the transmission of video and audio data.

The peripheral devices 108 may include devices for exchanging tactile, ultrasonic, and/or other diagnostic information—for example, utilizing the teachings of patents and patent applications related to the present disclosure, including U.S. Pat. No. 6,491,649, U.S. Pat. No. 6,726,638, and U.S. patent application Ser. No. 10/703,706, each of which is hereby incorporated by reference. Tactile data peripheral devices permit a physician to perform a direct physical examination of a patient's body without direct physical contact or proximity between the patient and the physician. This allows physical data of the type normally acquired from direct manual contact between the patient and the physician to be gathered and transmitted via conventional global communications systems. To date, “telemedicine” or the exchange of medical information between a patient and physician for the purpose of rendering a diagnosis and treatment plan, can only proceed to a point; and if the physical exam findings become critical in the decision making process, the patient is advised to actually see their personal physician or present to an emergency room where a physician can perform a physical examination. This inability to acquire physical data remotely and transfer it reliably to a physician in another location is a barrier to the evolution of medical practice and the ability of medicine to capitalize on the effectiveness and efficiencies that other business are enjoying with respect to the advances in global communications platforms and a potential global consumer audience.

As used herein, the following terms shall have the meaning indicated:

“Sensory modulation subunit” means any device capable of (1) detecting a force applied to the device and generating an output signal related to the detected force; and/or (2) receiving an input signal and generating a force and/or displacement related to the received input signal.

“Hand control unit” or “HCU” means any device adapted to contact or receive a portion of a user's body—such as a user's hand—and having sensory modulation subunits that can be accessed by the received user's hand.

“Patient examination module” or “PEM” means any device adapted to receive a portion of a person's (or other biological organism's) anatomy and having sensory modulation subunits that are adjacent to the received portion of anatomy. PEMs may be used in accordance with the present invention for patient examination, but the term “PEM” is to be understood to also encompass devices adapted for tactile sensing of anatomy for other purposes or for tactile sensing of other objects or substances.

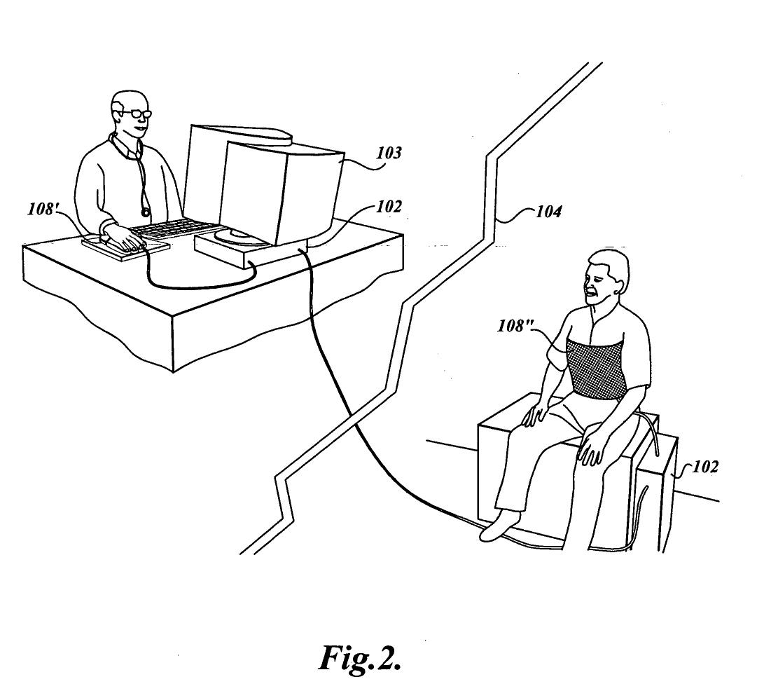

Referring now to FIG. 2, the remote acquisition and transmission of physically derived medical data includes three general parts—a hand control unit 108′ (HCU), a patient examination module 108″ (PEM), and computer software to control the acquisition, calibration, transfer, and translation of the physical data between the physician (through the HCU) and the patient (through the PEM). The present invention allows a physician to apply hand pressures to the HCU 108′ that are transmitted to a remotely situated patient and applied to selected portions of the patient's body through the PEM 108″. The pressure response from the patient's body is transmitted back to the physician, thereby simulating direct contact between the physician and patient. The tactile data is transmitted between the physician and patient computers 102 over the network 104.

As disclosed in the parent patents, the system may include the ability to record and playback a tactile portion of a physical examination. In particular, the tactile portion of the physical examination may be recorded directly into medical records and replayed, for example, to consultants, covering physicians, patients, medico-legal situations, research, teaching, patient information, etc.

Referring again to FIG. 1, the software includes of two related components—a physician software system 106 and a patient software system 106′. Each software system 106, 106′ may be either a locally-installed, freestanding software version or an application embedded in and accessible through a Web page or Web-based document. In the preferred embodiment, users of the station 100 are first registered and provided with a mechanism for logging onto the software 106 or 106′. It is contemplated that each user will log onto a secure server system 112, which is shown as a separate system 112 in FIG. 1, but may alternatively be, for example, the physician's computer 102. The user is authenticated by suitably secure methods, such as a secure user name and password or biometric identification system (not shown). Once the user is logged on and authenticated, various aspects of the software's functionality may be utilized. The secure server system 112 also provides the user with access to an electronic medical records database 110, as described in more detail below.

Software Functionality

The physician software 106 and the patient software 106′ provide differing levels of access to the electronic medical records database 110. The patient software 106′ includes a subset of functionality that is common to both software systems 106, 106′, while the physician's software system 106 includes full functionality. The differential functionality is important for maintaining the security and integrity of the electronic medical records database 110, as will be more clear from the description below.

In the current version of the invention, when the registered user launches the software application 106, 106′, a conventional log-on screen is presented (not shown), allowing the user to log on using a user name and password architecture. Alternatively (or additionally), a peripheral device providing biometric identification of the user, such as a fingerprint or optical scanner (not shown), may be utilized. The software systems 106, 106′ (with the local operating system) handle all data transmission protocols, including interfacing with the audio and video device drivers of the host computer 102, collection and storage of all audio, video, and text data, encryption of all data (both command and informational data), transmission of the encrypted data to the intended recipient of the data stream, and subsequent decryption of the data for viewing by the intended recipient.

After logging onto the secure data network, the software systems 106, 106′ detect the user's Internet connection and identify the optimal upload capability of the user. Based on the identified data upload rate, the video data is automatically presented to the user in an optimal configuration of image size, compression quality, and frame rate in order to provide video quality based on the bandwidth availability. With current versions of the software 106, 106′ there are five preset configuration options—Dial-up (56 k), ISDN (128 k), DSL, Cable, and LAN. Although the computer preselects the optimal starting configuration, the user may override the preselected setting. The software 106, 106′ also accesses the computer's audio and video drivers. When an optimal transmission speed has been determined, a dialogue box is displayed giving the test results and requesting confirmation, or selection of an alternative data transmission speed.

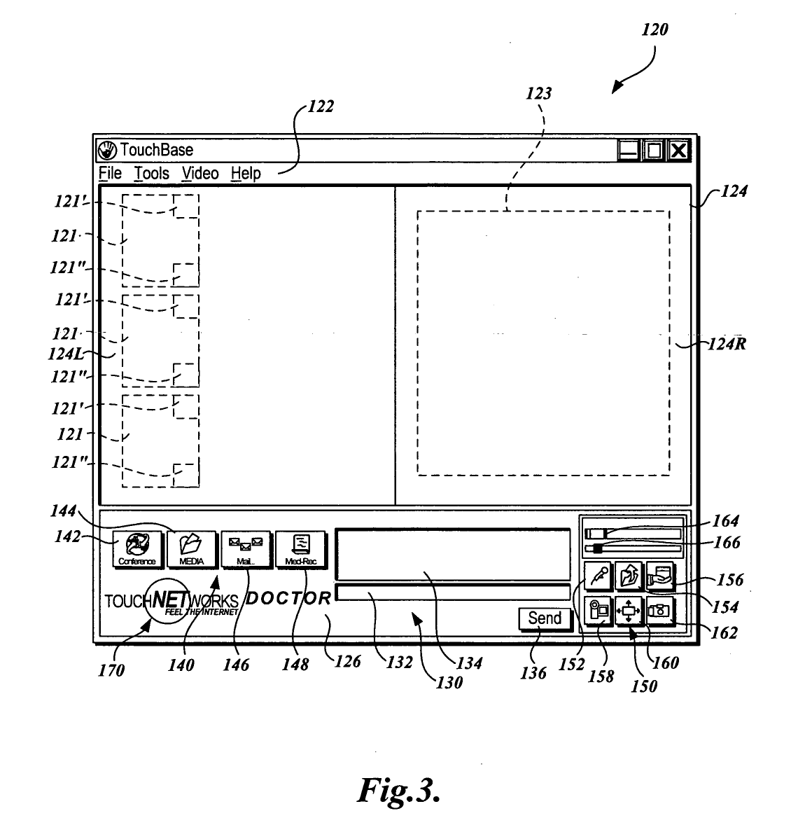

Referring now to FIG. 3, a home screen 120 is then displayed on the user's monitor 103 (FIG. 1), including an application menu bar 122 (providing alternative access to the functions discussed below) located along the top of the home screen 120, a video viewing area 124, and a control area 126. The control area 126 includes four general regions—an instant text messaging area 130, a functions control area 140, a communications control area 150, and an advertising area 170. Communication among participants using the system can be through at least three different methods—audio, video, and text information—all of which are preferably encrypted and compressed prior to transmission (to be decompressed and decrypted by the recipient system).

Video Viewing Area

In the preferred embodiment, the video functions of the software 106, 106′ utilize camera driver software of any suitable digital camera driver installed on the local computer. Using a conventional Webcam (e.g., peripheral 108), for example, video data can be sent in real-time between conferenced users of teleconferencing stations 100.

In the preferred embodiment, the left side 124L of the video viewing area 124 normally displays video information from the local user and the right side 124R of the video viewing area 124 normally displays video information from the remote user.

The software 106, 106′ will accommodate more than two users. When more than two user's are connected, the local user (left) side 124L of the video viewing area 124 displays smaller “thumbnail” video images with video data from each of the individual participants logged into the conference. The thumbnail video images are smaller, with fewer pixels and a slower refresh rate than the full video data available. The remote user (right) side 124R of the video viewing area 124 displays the full video data from any one of the individual users. The focal user simply selects any one of the multiple thumbnail images displayed on the left side 124L of the video viewing area 124 to select the desired video data to be displayed.

The video data presented in the remote user side 124R of the video viewing area 124 may comprise any of several types of data from the selected source, such as a video image from a digital camera (e.g., peripheral device 108, FIG. 1), or other data from the selected source's computer 102. Other source video information may include, for example, a full screen capture of the source's system desktop or an active software program currently visible to the source user.

Instant Text Messaging Area

The instant text messaging area 130 includes a text message window 132, text record box 134, and a send button 136. A typed text message can be sent interactively to all active conference participants (initiation of conferences is described below) by typing the desired text information into the text message window 132 and then clicking on the send button 136. The entered message is transmitted to the other conference participants and simultaneously moved out of the text message window 132 and into the stack in the text record box 134. The text record box 134 displays in sequence all of the messages from every active conference participant.

Communications Control Area

The communications control area 150 includes an on/off video toggle button 158 that allows the user to selectively discontinue transmission of the image data from the local computer 102. A video image size control 160 is provided to adjust the display size of the remote and local video pictures. For example, the video image size control 160 may be used to enlarge the image to 200% or a full screen image. Based on the predetermined bandwidth, video is currently encrypted, compressed, and then transmitted at any of six preset transmission rates. The factors relevant to the optimal quality level include the image size (number of pixels), video frame rate, and data compression. While there are currently six preset levels, there can be any number of options and configurations and the fixed number in the current embodiment is not meant to limit the scope of the invention. It is contemplated that an embodiment of the present invention may implement a variable controller for each identified quality determinant factor that can be manipulated individually by the user.

A microphone (e.g., peripheral device 108, FIG. 1) may be utilized for audio conferencing. One version of the present system (not shown) utilizes a walkie-talkie type of audio scheme wherein the audio is normally off and there is an audio transmit button (not shown), audio hands free button (not shown), and an audio volume indicator (not shown). Audio data is transmitted whenever the user depresses the audio transmit button or by checking the “hands free” audio button to keep the audio channel open continuously. Unchecking the hands free button returns the program to the default audio off state.

In the preferred embodiment, however, full duplex audio transmit and receive functionality is provided. An audio toggle button 152 is provided that allows the user to selectively cease transmission of the audio data from the local computer 102. In the full duplex embodiment, the audio system preferably incorporates a noise gate/limiter and noise/echo cancellation algorithms, allowing the user to adjust the decibel threshold that will activate the audio channel. This feature allows low volume noise to be cut off (i.e., not transmitted over the local user's audio channel) and prevents unnecessary data from being transmitted.

The noise gate control includes a sound volume indicator bar 164 that indicates relatively the sound volume being detected by the local microphone 108, and an audio threshold marker 166, a user-adjustable control that is movable to set the volume cut-off level. The threshold marker 166 is directly below the indicator bar 164, so the user can readily set the threshold marker 166 relative to the displayed sound volume shown on the indicator bar 164. The user simply moves the threshold marker 166 to set the gate function so only sound volumes above the threshold (to the right of the threshold marker 166) will be transmitted through the audio channel. This reduces unwanted noise and feedback through the system, especially when multiple simultaneous users are in a single conference. Utilizing the noise suppression algorithms, the audio channel is always on and communication can be done automatically and naturally. While one specific noise suppression display is discussed above, it will be readily apparent that any number of options and configurations are possible, without departing from the present invention.

As discussed above, the physician software 106 has enhanced functionality not included in the patient software 106′ to provide capabilities that are not needed or are not appropriate for the patient. In the communications control area 150, these enhancements include media capture, file sharing, and desktop sharing functionality.

Referring still to FIG. 3, an image capture button 162 is provided that captures a still frame of the video displayed on the remote (right) side 124R of the video viewing area 124. The captured frame may be stored in any type of video data format (e.g., JPEG, GIF, TIFF, etc.) on the local computer 102. Each time the image capture button 162 is selected, an image is captured and stored in an image file. Each image is stored with a date and time stamp. As discussed in more detail below, the function control area 140 includes a media button 144 that provides ready access to the saved image data. The image capture button 162 allows for images to be saved and integrated into electronic medical record documents, as discussed below.

The physician software 106 also has enabled a file share button 154 that facilitates the sharing of files stored on the user's computer 102 with other conferenced users. Selecting the file share button 154 opens a search window for locating files on the local computer 102. The user selects a file to be shared with some or all conference participants (conferencing is described below) and identifies the intended recipients of the selected document. Each identified recipient receives an on-screen message identifying the sender, requesting to download the selected file, and requesting a response (accept or deny). The selected file is then transferred to all accepting participants.

The physician software 106 also has enabled a desktop-sharing button 156 that enables the user to transmit an image of the user's desktop to conference participants. Clicking on the desktop sharing button 156 captures a picture of the user's active desktop. This information is automatically formatted to the appropriate screen size to optimize data transmission with the users available bandwidth. Since the desktop sharing function utilizes the same data channel as the local video source the user is prompted to turn off the local video. The conference participants then see a desktop-sharing icon (not shown) substituting for that individual's video data on the left side 124L of the video viewing area 124. Any conference participant wanting to view the source desktop can click on the corresponding thumbnail and the shared desktop will be displayed on the right side 124R of the user's video viewing area 124. This function allows any information visible on the source's monitor 103 to be viewed by other conference participants in real-time, even if the conference participants do not have specific program readers or viewers for the shared information.

The desktop-sharing button 156 can also be used to permit a remote user to take control over the source users desktop. After a user engages the desktop sharing button 156, a remote user can use a menu command to request authorization to take control of the user's shared desktop. If the request is granted, the remote user can remotely control the user's shared desktop. When the desktop sharing function is turned off, the local video may be turned back on and viewed by other conference participants.

In a multiuser conference, it is anticipated that there may be times when a small subset of users may desire to have a private conversation during an active conference without the information being shared with the rest of the conference participants. As discussed above, when more than two people are in conference together, the video viewing area left side 124L automatically reformats to a number of smaller “thumbnail” video images, one from each of the individual participants logged into the specific conference. Each user can select from any of the thumbnail images to “bring up” or display the full video data for the selected video source on the video viewing area right side 124R. Additionally, in a multiuser conference setting, there is anticipated a need to identify the active source of the current audio information being transmitted. In order to accomplish this, the border around the thumb of the active audio source changes color (to red or any other preset color determined by the user) in order to draw the user's attention to the active audio source. While the software may be designed to accommodate any number of conference participants, the viewing area is currently designed to present twelve simultaneous thumbnail images. In conferences where more than twelve users are in a single conference, in addition to the local video, the user can choose which of the other users are to be displayed in thumbnail. When a user other than the twelve chosen for the display becomes an active audio participant in the conference, the software allows recognition of the individual by presenting a small pop-up bar (not shown) with the user's name in it at the bottom of the video viewing area 124. Clicking on the bar will open a separate thumbnail video window that will allow the other viewers to see this individual if they so choose.

Within the thumbnail viewing area 124L, each thumbnail includes two control buttons, a video viewing icon, and a private message icon. Clicking on the video-viewing icon selects that thumbnail image as the source image for the full display on the remote portion of the video viewing area 124R. To view the enlarged real-time image from one of the other sources, the user selects the desired thumbnail's video viewing icon and the source will automatically change to the desired view. With this feature, the user can choose which video source they wish to see at any time or toggle through the images, as he or she desires.

The private message icon allows for a direct communication link between the user and the selected remote source (participant). The private communications channel uses a single secure, encrypted, audio- and text-messaging channel for participants to hold a private subconference. When in a private conference, an indicator appears on the other participants' monitors in the thumbnail views for the privately subconferencing individuals and is used to notify the other users that a private subconference is occurring. All individuals, including those in the private conference, continue to see and hear what transpires in the main conference. The main conference audio channel is muted for the private message participants and can be restored to full conference participation by clicking on the main audio button and restoring the channel to on. Closing the private message window automatically restores the main audio to on. Text and audio information transmitted via the private message channel are not subject to data recording, storage, or archiving.

Function Control Area

The present invention enables two or more users to interact with each other in real time using audio, video, and text within a secure environment. Once an individual opens the application and logs on to the secure server system 112, he or she becomes an “active” participant on the network. Active users have access to the secure e-mail functions and some level of access to the electronic medical record 110 functions, as discussed below. The function control area 140 includes a conference button 142 that allows for a secure data connection to be established for direct real-time information exchange between two or more users.

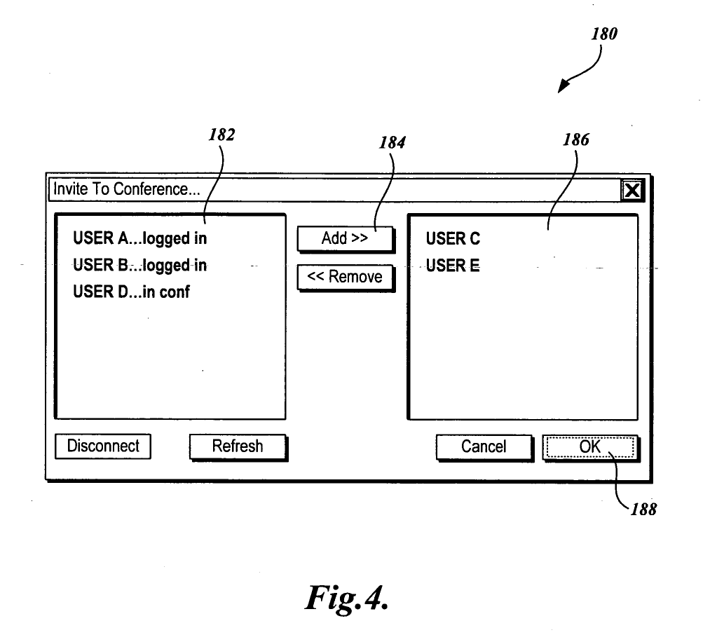

To initiate a conference, the user selects the conference button 142 to generate an invitation window 180, shown in FIG. 4, displaying a user list 182 of all users currently logged on to the secure network. The user selects an invitee's name from the user list 182 and then clicks the add button 184 to move the selected name into an invitee list 186.

After the invitee list 186 is complete, the user clicks the OK button 188 to generate a software dialogue box to each of the invitees, asking if the invitee wishes to start a conference with the selected invitees. Each invitee then has the option to either accept or decline the incoming request for a connection. If the invitee elects to conference, a secure datalink is established between the user initiating the conference request and all invitees that have accepted the request to participate. When the conference is established encrypted audio, video, and text information can be exchanged among the participants. If an invitee declines the request for conference, then no secure connection is established with that invitee and a decline message is sent back to the user requesting the conference. If no invitee accepts the invitation, no conference is initiated.

When a secure conference connection is established, the status of the conference participants is changed to “in conference” from “logged on” at the server level and no other individuals can connect to that individual until they end their current conference. If a user attempts to establish a connection with a user that is already in-conference, he or she will receive a message that the selected user is not available.

When a person wishes to end participation in a specific conference, the participant selects the conference button 142 and then selects the disconnect button (not shown). This disconnects the user from the current conference, but the user remains logged onto the secure server system 112. The user can then elect to work with the functions available outside of conference, initiate a new conference, or log off of the secure server system 112.

The e-mail button 146 allows the user to access the secure e-mail functionality of the system. From within the secure network, encrypted e-mail messages can be sent to any registered user. Conventional e-mail functionality is provided, including listing, reading, composing, saving, forwarding, and deleting e-mail messages. In the preferred embodiment, this secure e-mail system is independent of any other e-mail system that a user may have on his or her computer. The e-mail system is encrypted and runs on a secure data network. As such, these e-mail messages cannot be sent or received from individuals who are not registered users and are independent of any other e-mail programs on the user's computer.

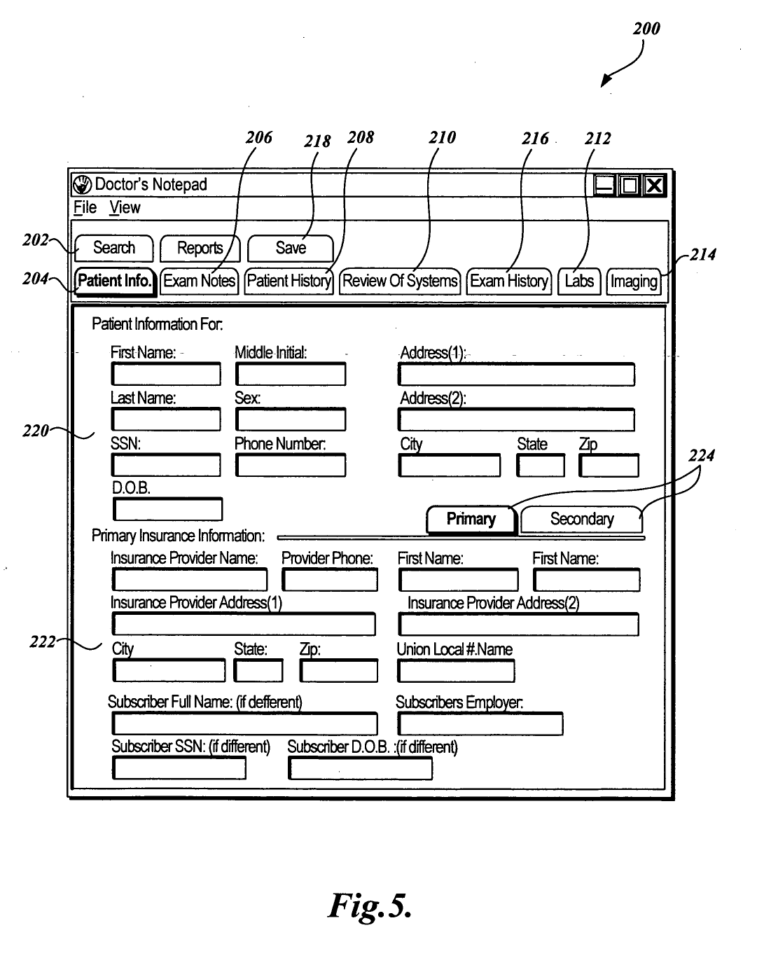

The electronic medical records button 148 provides access to at least a portion of the medical records database 110 (FIG. 1). The teleconferencing station 100 will record medical information from a variety of sources—for example, from the patient, the physician, electronic data, laboratory and radiology data, photographs, and audio clips. Selecting the medical records button 148 brings up a tabbed medical records window 200, as shown in FIG. 5 (shown with the patient information tab 204 selected). The patient information tab 204 provides a template that allows the user to input information into general demographic fields 220, such as name, social security number, phone number, and the like. Insurance fields 222 are also provided for entering insurance information, such as the provider name and address, group number, and the like. In the preferred embodiment, the insurance information for a secondary carrier may also be entered, with navigation buttons 224 provided for switching between the primary and secondary templates.

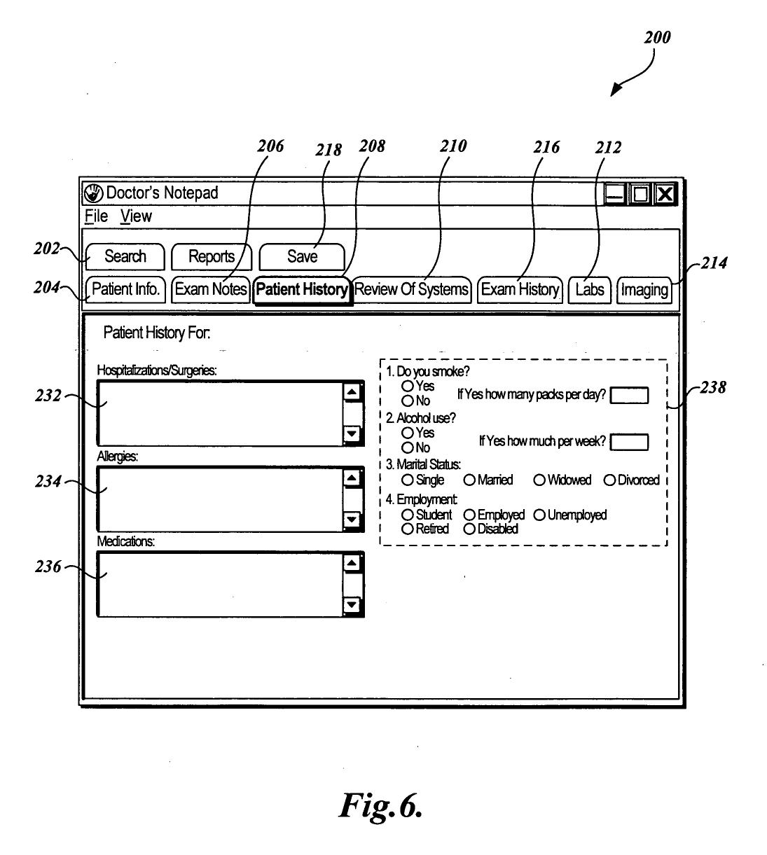

FIG. 6 shows the patient history tab 208 of the medical records window 200 that allows the user to record past medical history, including a prior surgeries and hospital admissions field 232, an allergies field 234, a medications field 236, and social history/habit information fields 238. As shown in FIG. 6, the social history/habit fields may include, for example, fields to record the user's marital and employment status and information regarding habits that may be medically relevant, such as smoking and drinking habits.

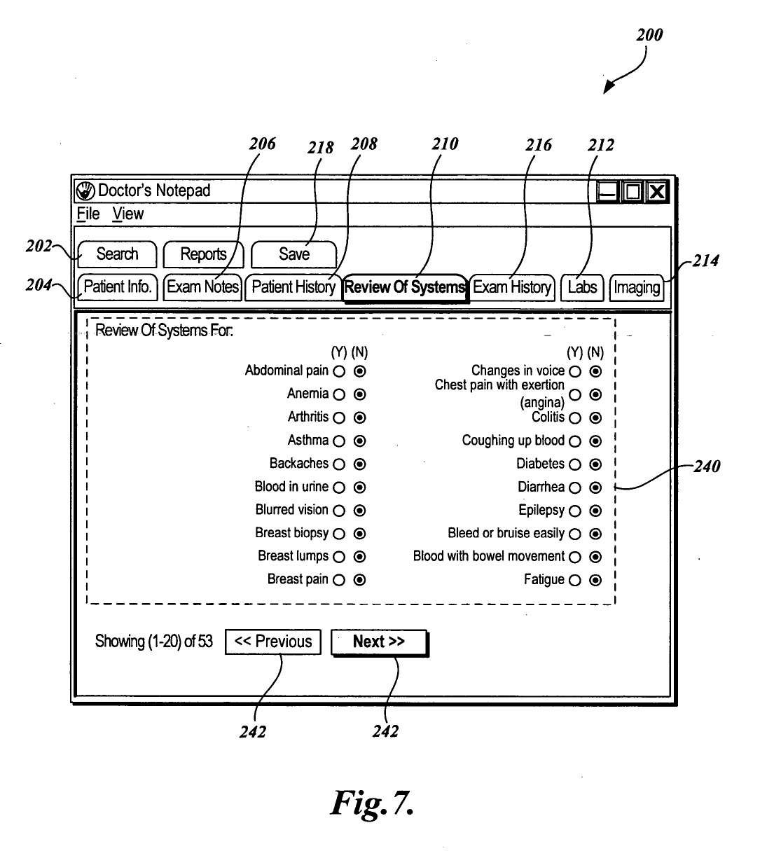

Referring now to FIG. 7, the review of systems tab 210 allows the user to input a comprehensive body review of systems. The review of systems tab 210 has multiple specific common questions fields 240 presented in a YES/NO format, and may include navigation buttons 242 if the questions are presented in several pages. These fields 240 allow the patient to update his or her general health information at any time. When new data is input and saved, a permanent time and date stamp is incorporated into the saved document so a trail can be made identifying who made the change and when the change was made. In the preferred embodiment, any time a user (patient or physician) brings up a medical record, only the most recently saved, current information is brought up, so that the user sees the most current information.

The physician software 106 also allows the physician to make changes to the patient information discussed above, in order to update the patient's medical record. The electronic medical record functionality for the physician includes additional functionality to provide a comprehensive medical records data base system to accommodate the medical information recording requirements.

The basic medical records window 200 pages include a search tab 202, the patient information tab 204, a physical examination notes tab 206, the patient history tab 208, the review of system tab 210, a laboratory information tab 212, an imaging tab 214, an examination history tab 216, and a save tab 218. Similar to record keeping in a conventional medical encounter, some of the electronic medical records (“EMR”) data is data directly input by the patient, some from physician input, and some from outside sources, such as lab or x-ray providers. The patient information tab 204, patient history tab 208, and review of systems tab 210 are discussed above and are also accessible to the physician software 106.

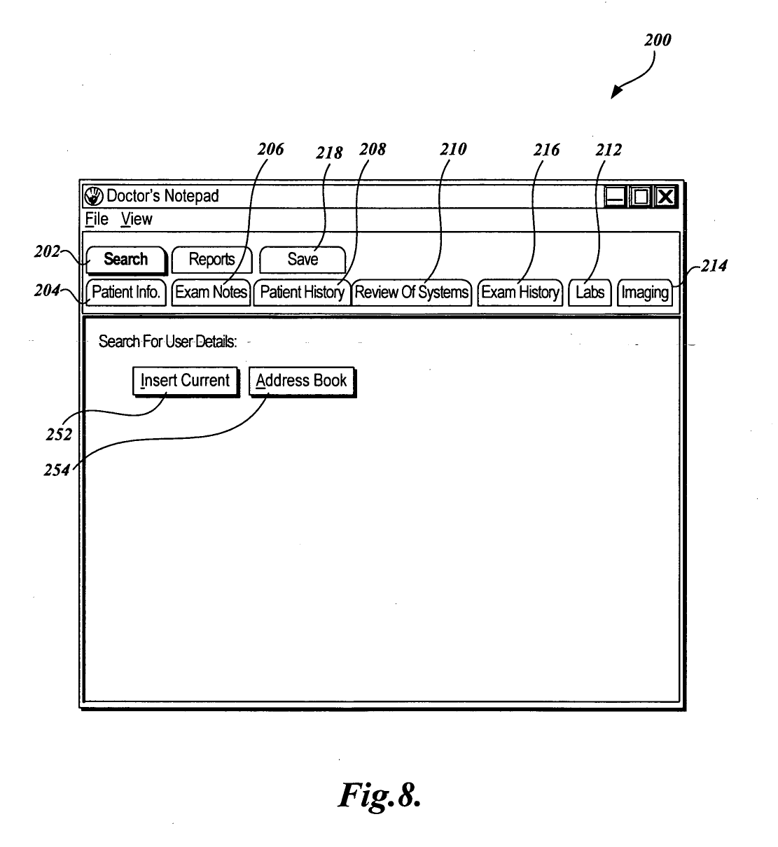

The search tab 202 is the patient access page, as shown in FIG. 8. The physician is presented with two options for finding the medical record of the patient of interest—an insert current button 252 and an address book button 254. The insert current button 252 may be used when a physician is in a conference with one patient and allows an automatic download of the conferenced patient's medical information. In a multiconference situation (i.e., more than two conference participants) or when a physician needs access to an unrelated individual's medical information, the address book button 254 may be used to select the desired patient from a list of registered users. Of course, the search function is not available on the patient software 106′, which only allows direct (and limited) access to the patient's own specific medical record.

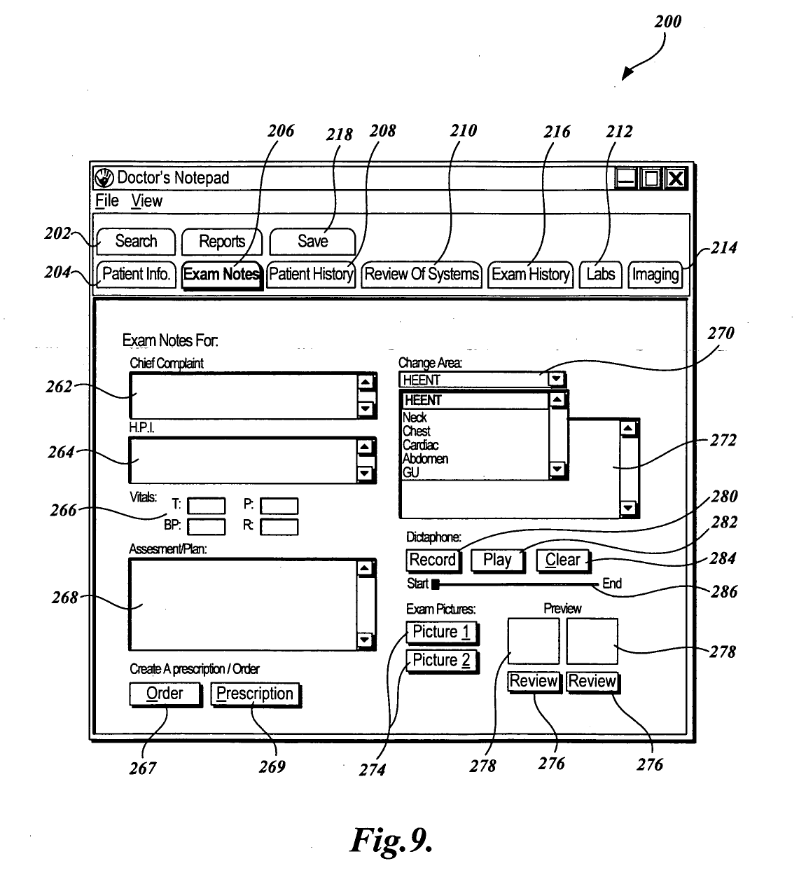

The exam notes tab 206 is shown in FIG. 9. This is the heart of the physician data recording aspect of the medical record. The general organization and presentation are similar to a standard medical records document. There are specific text fields for recording the chief complaint 262, history of present illness (HPI) 264, vital signs 266, and assessment/plan 268. A drop-down field identifies selectable regions of the body via a list in a drop-down box 270, which is linked to a specific text field 272. For example, the listed body regions may include head, neck, chest, cardiac, abdomen, genitourinary, extremities, neuro, and skin. Selecting a specific body region in the drop-down box 270 allows the physician to record his or her notes or exam findings in the corresponding text field 272. Two picture buttons 274 are selectable to capture a still frame image similar to the image capture button 162 discussed above (FIG. 3) directly into the medical record document. Two image review buttons 276 and preview windows 278 are provided to facilitate viewing the captured images.

The medical record also includes an audio record, i.e., Dictaphone, function with a record button 280, a play/stop button 282, a clear button 284, and timer indicator 286. The Dictaphone function in the current embodiment allows recording up to three minutes of audio information by the physician directly into the medical record—for example, to add supplemental information into the record, to take notes, or to make specific reminders about tasks that may need to be done or followed up. The exam notes tab 206 also includes an order button 267 and a prescription button 269 that take the physician directly to the order writing and prescription writing functions of the medical record. These functions are also accessible through the secure e-mail system, and are described in more detail below. Data on the exam notes tab 206 is accessible only on the physician software 106. Whenever the data is saved, the information is permanently date- and time-stamped, that particular record is write-protected, and a permanent entry into the medical record is created. If the data is not saved, none of the information is entered into the medical record. The last saved encounter constitutes the working template that can be amended, as appropriate, for the next patient encounter.

The laboratory tab 212 and imaging tab 214 (details not shown) can be used to interface with laboratory and outside imaging data stored within other applications or from outside imaging sources, as are well known in the art. These external sources of information can be recorded within the medical record, and retrieved by the search functions within the laboratory tab 212 and imaging tab 214.

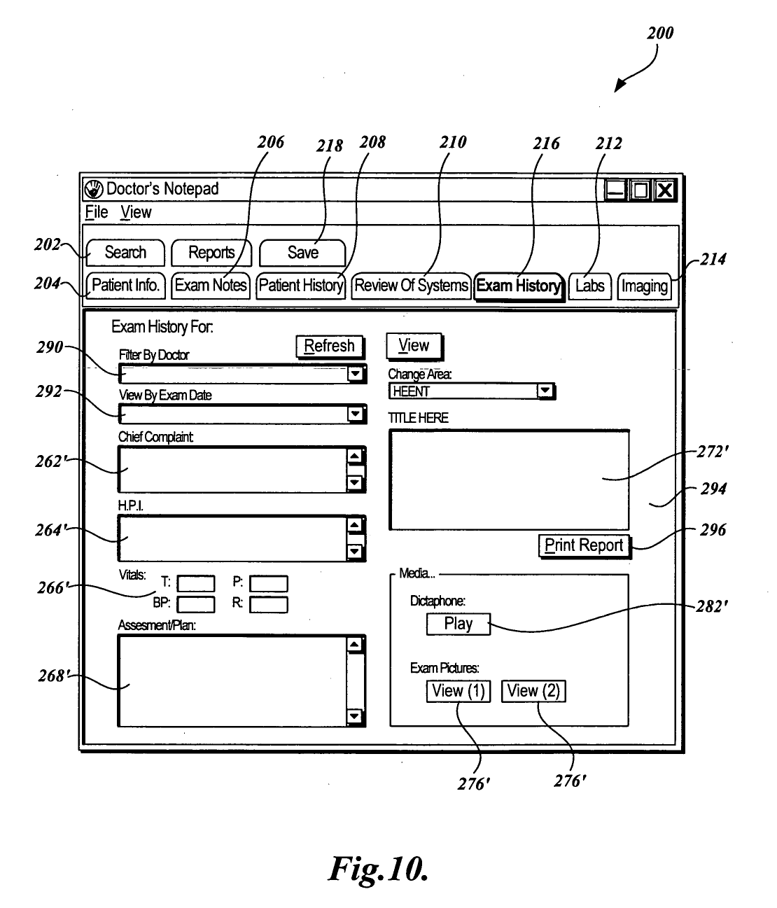

FIG. 10 shows the exam history tab 216 that serves as the physician's access point to previously-saved exam records that constitute the patients saved medical record file. The data view area 294 is arranged similar to the exam notes tab 206. A drop-down physician search field 290 and a date search field 292 allow information searches by physician and/or by date of exam. (Any physician who generates an EMR document for the patient is automatically added to a physician list in that patient's medical record.) To find a particular EMR document, for example, a user may select a physician from the drop-down physician search field 290. The dates of all notes generated by the selected physician or caregiver is then imported into a drop-down list in the date search field 292. The EMR document from the selected exam encounter is then downloaded into the viewing area 294 of the exam history tab 216. The selected exam information is downloaded into the chief complaint field 262′, the history of present illness field 264′, the exam areas text field 272′, the vital signs fields 266′, and assessment and plan fields 266′. There are also exam picture buttons 276′ to access stored images associated with the exam record and a Dictaphone player control 282′ to play back any stored audio information. A print report button 296 allows the document to be printed or forwarded to another user via the secure e-mail system discussed above.

The save tab 218 on the medical records window 200 allows the user to save the record information in a read-only file with a permanent time, date, and physician stamp.

In the preferred embodiment, with each conference or examination encounter, there is the ability to store associated audio and video data in one of two configurations, depending on the amount of data and memory the user wishes to utilize. Prior to initiating a conference, a user can elect to record the entire conference including all aspects of the audio, video, and text data as a single large file. The entire conference is recorded, and can be accessed via the media button 144 (FIG. 3). More typically, users would desire only limited amounts of information storage, such as the medical record document and/or specific still images acquired from the video data stream. These smaller sets of information significantly reduce the file storage and memory requirements and are significantly more manageable and practical for the user. Selecting the image capture button 162 in the communications control area 150 acts essentially like a camera shutter and stores an image of the remote user video information with an associated time and date stamp. This image data is stored and can be integrated into other data and record keeping functions of the application. The media button 144 allows for direct access to the stored media files, including audio, video, and text data if the entire conference is stored in a large file, or any stored subsets of this information. The media files can also be exported to other software applications, uploaded into the medical record, or e-mailed to other system users.

Advertising Area

Referring again to FIGS. 1 and 3, it is contemplated in the preferred embodiment that advertisements, ranging from banner to rich media, may be broadcast directly to the user via the secure server system 112. It will be appreciated that, conventionally, most advertising over the Internet is presented to the user as added text or media around a Web page or as a separate pop-up window and is easily bypassed by the user. The teleconferencing stations disclosed herein would typically engage users for periods on the order of several minutes and present an opportunity to provide commercial information to users that cannot be easily bypassed. Commercial messages may be transmitted to the user—for example, for a fixed time period via an ad window (not shown) or located within the advertising area 170 of the home screen 120. Since each user is registered and demographic information is stored in the secure server system 112, this presents the opportunity for commercial messages to be selected that are specifically targeted to the particular user.

For example, the secure system server 112 may have a library of product or service information in one or more display formats. When a registered user logs into the secure server system 112, the system may automatically select an appropriate product information display to provide to the user based on the user's demographics, such as the user type (physician or patient), address, gender, and/or the like. The information may then be provided to the user in any of the modes discussed above, for example with a display in the advertising area 170 of the home screen 120.

Physician Order and Prescription Writing

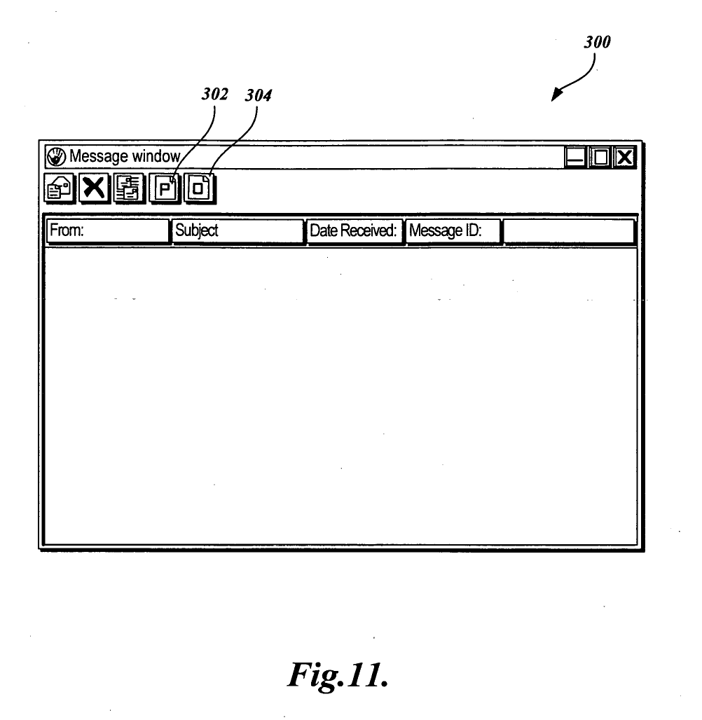

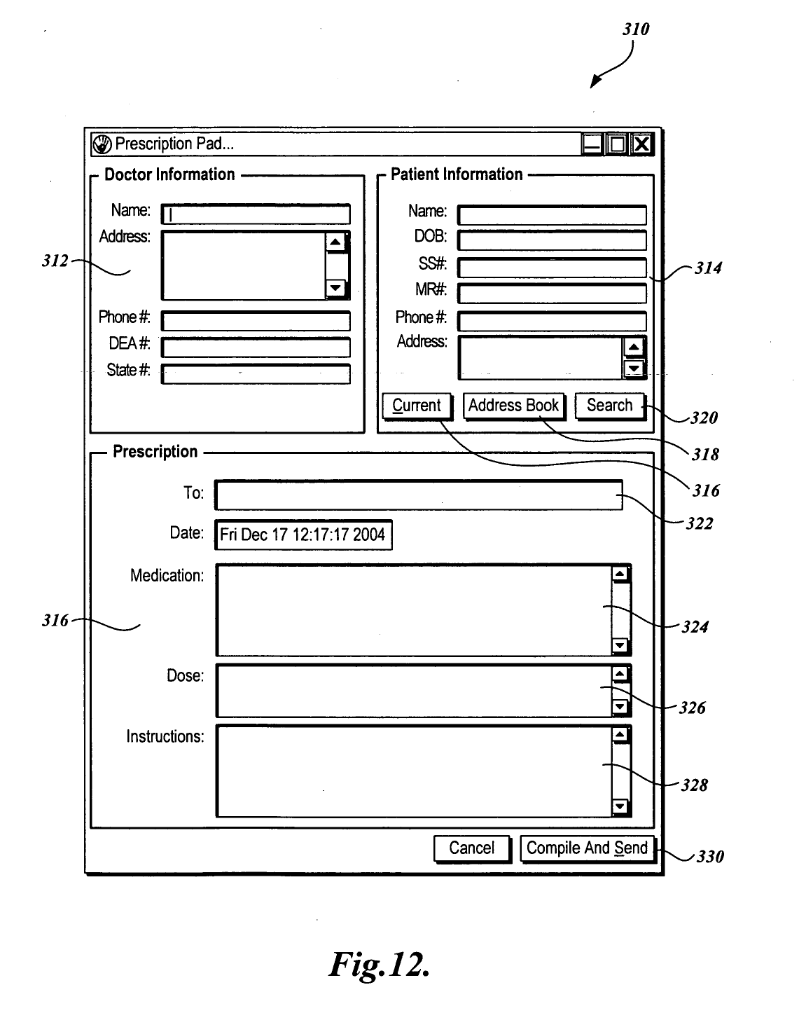

The physician software 106 enables secure prescription writing and physician order entry. This functionality increases the physician's workflow efficiency and helps to reduce medical errors. The physician can access these functions through the exam notes tab 206 of the medical records window 200, as discussed above, or can select the e-mail button 146 from the home screen 230 to bring up the e-mail window 300 shown in FIG. 11. To write a prescription, the physician selects the new prescription button 302 near the top of the e-mail window 300, which brings up the prescription pad window 310 shown in FIG. 12. The prescription pad window 310 includes three general areas, the ordering physician demographics fields 312, the patient demographic fields 314, and the prescription fields 316. The physician demographic information is generally already entered into the system (for example, during the initial registration) and is automatically inserted into the physician demographic fields 312, including name, address, phone number, and DEA/state drug number information downloaded from the system. Typically, the patient demographic information has also been entered in the demographic information fields 220 of the patient information tab 204 (see FIG. 5) and can also be downloaded ,directly into the patient demographic fields 314. Patients may be identified for prescription writing functions in one of three ways. The physician can select the current button 316, if the physician is in a one-on-one conference with a patient, to insert the conferenced patient's demographic information. To write a prescription for any other patient, that patient's information can be imported into the prescription template by selecting the address book button 318 and selecting the appropriate patient from a list or by selecting the search button 320 and locating the patient information with a global search. These methods of locating information in a software system are well known in the art.

After the physician and patient demographic information is completed, the prescription fields may be manually filled in. A target pharmacy is designated in the “to” field 322, and can be any pharmacy having Internet access, compatible software, and registered on the secure server system 112. Pharmacy targets may be identified by a search methodology similar to that described above. The physician then enters the desired information in the medication field 324, the dose field 326, and the instructions field 328 (typically including the quantity of the medication to be dispensed). Multiple medications can be ordered on a single form. It is contemplated that this information may also be tested against drug interaction and potential allergy interaction early warning safety software and information taken from the patient's medical record information. When the information is completed, the physician presses the compile and send button 330. The physician is presented with a formatted version of the prescription information in an e-mail format. This second step provides the physician an opportunity to confirm the medication order as well as determine if copies need to be sent to other sources in addition to the pharmacy (forwarded to their office computer, to another physician, etc.). The information is also permanently archived in the patient's medical record and a copy can be viewed through the exam history window.

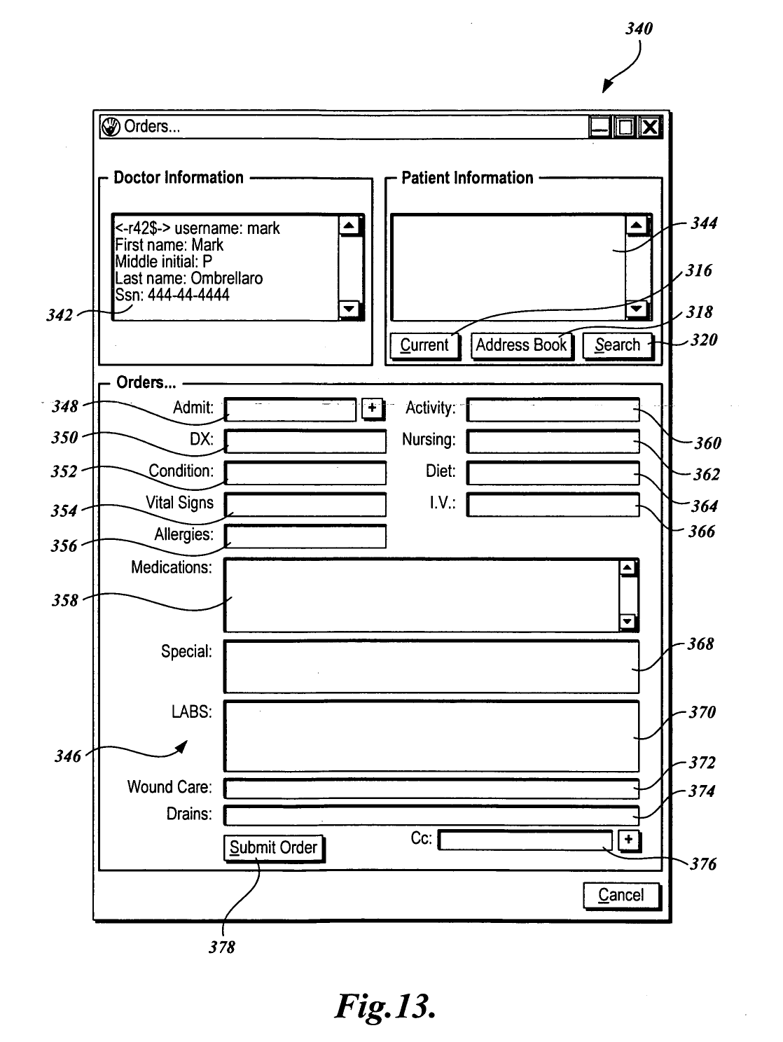

Referring again to FIG. 11, the physician may select the new order button 304 to open an orders window 340, as shown in FIG. 13. The orders window 340 has a general layout similar to the prescription pad window 310, and includes fields for the physician demographics information 342, the patient demographic information 344, and the order template 346. Physician and patient demographic information may be imported into the fields exactly as described above. The order template is designed with multiple text fields and arranged with headings that are typical for a full hospital admission. In general, the currently identified text fields include admitting floor/area designator 348, diagnosis 350 (with ability to import standard ICD-9 coding methodology), patient's condition 352, vital sign frequency 354, allergies 356 (that can be added manually or automatically downloaded from the patient's medical record information), medications 358 (that can be added manually or automatically downloaded from the patient's medical record information), activity orders 360, specific nursing orders 362, diet 364, intravenous (IV) fluid orders 366, special instructions field 368, laboratory orders 370, wound care orders 372, and drain/tube orders 374. It is contemplated that this information can also be tested against drug interaction and potential allergy interaction early warning safety software and information taken from the patient's medical record information. Physicians can fill out any or all fields of the order window 340, depending upon the extent of the orders that are required at the time.

After the physician has completed the order, there is also a cc: field 376 to designate additional recipient sites for the order sheet. While in the present embodiment of the system, the order window 340 information is automatically sent to the admitting floor; other care areas, such as the laboratory, radiology, and pharmacy, may need to receive a copy of the order sheet in order to execute the task specified in the order sheet. Specific targets may be identified by a search methodology similar to that described for conferencing or finding a patient's medical record. After completing the order window 340, the physician clicks the “submit order” button 378, which presents the physician with a formatted version of the order sheet as described for prescriptions above. This second step is a chance for the physician to confirm their medication order as well as determine if copies need to be sent to other sources in addition to the pharmacy (forwarded to their office computer, to another physician). After the physician confirms their orders and identifies all of the appropriate recipients for the order sheet, the order is sent to the designated target areas. The designated target areas can be any hospital or independent target area with Internet access, the software, and participating on the secure network.

In the preferred embodiment, the information from the prescription window 310 and from the order window 340 is permanently archived in the patient's medical record and a copy can be viewed through the exam history window.

While the preferred embodiment of the invention has been illustrated and described, it will be appreciated that various changes can be made therein without departing from the spirit and scope of the invention.

1. A teleconferencing system comprising:
a first teleconferencing station having a first digital camera;
a second teleconferencing station located remotely from the first teleconferencing system, wherein the second teleconferencing station receives image data from the first digital camera over a network; and
an electronic medical records database having a plurality of medical records, the electronic medical records database being accessible to the second teleconferencing station;
wherein the second teleconferencing station selectively records image data received from the first digital camera into one of the plurality of medical records.

2. The teleconferencing system of claim 1, wherein the second teleconferencing station further comprises a second digital camera and the first teleconferencing station receives image data from the second digital camera.

3. The teleconferencing system of claim 2, wherein the first and second teleconferencing stations each further comprises a microphone and a speaker such that the first and second teleconferencing stations exchange audio information over the network.

4. The teleconferencing system of claim 2, wherein the medical records include fields for entering medical history data.

5. The teleconferencing station of claim 2, wherein the imaging data received by the first teleconferencing station is compressed and encrypted.

6. The teleconferencing system of claim 2, wherein the second teleconferencing station further comprises a template for recording a medication prescription.

7. The teleconferencing system of claim 6, wherein the recorded medication prescription is saved in one of the plurality of medical records.

8. The teleconferencing system of claim 2, wherein the first teleconferencing station and the second teleconferencing station each includes an encrypted e-mail system such that encrypted e-mail messages can be sent between the first teleconferencing station and the second teleconferencing station over the network.

9. The teleconferencing system of claim 2, wherein the first teleconferencing station and the second teleconferencing station communicate over a public worldwide network.

10. The teleconferencing system of claim 2, wherein the first teleconferencing station and the second teleconferencing station can exchange encrypted instant text messages.

11. The teleconferencing system of claim 2, further comprising a third teleconferencing station having a third digital camera, and wherein the first teleconferencing station and the second teleconferencing station receive image data from the third digital camera.

12. The teleconferencing system of claim 11, wherein each of the first, second, and third teleconferencing stations selectively receives image data from each of the first, second, and third digital cameras.

13. The teleconferencing system of claim 1, wherein the first teleconferencing station further comprises a microphone and is adapted to selectively record audio data received by the microphone into one of the plurality of medical records.

14. A teleconferencing station comprising:
a computer having a monitor and a central processing unit, the computer adapted to receive and display live video data over the Internet;
a digital peripheral connected to the computer that records live audio and video data for transmission over the Internet; and
an electronic medical records database having a plurality of medical records, the electronic medical records database being accessible to the computer;
wherein the computer is adapted to selectively record at least a portion of the received video data into one of the plurality of medical records.

15. The teleconferencing station of claim 14, wherein the medical records include fields for entering medical history data.

16. The teleconferencing station of claim 14, wherein the imaging data received by the first teleconferencing station is compressed and encrypted.

17. The teleconferencing station of claim 14, wherein the computer includes means for recording a medication prescription and storing the medication prescription in one of the plurality of medical records.

18. The teleconferencing station of claim 14, wherein the computer further comprises means for exchanging secure e-mail over the Internet.

19. The teleconferencing station of claim 18, wherein the computer further comprises means for exchanging encrypted instant text messages over the Internet.

20. A teleconferencing system comprising:
a first teleconferencing station including a computer that is functionally connected to a global data network and digital video camera;
a second teleconferencing station including a computer that is functionally connected to the global data network, wherein the first and second teleconferencing stations are functionally connected such that they can exchange data over the global data network; and
an electronic medical records database comprising a plurality of medical records, each medical record including fields identifying a patient and at least one image field, wherein at least some of the plurality of medical records are accessible by the second teleconferencing station;
wherein the second teleconferencing station receives image data from the image recording device and selectively stores at least a portion of the image data in the at least one image field of a medical record.

21. A method for generating an electronic medical record comprising:
connecting a patient teleconferencing station to a physician teleconferencing station over a global data network, wherein the patient teleconferencing station includes a camera for recording digital image data;
generating a form for receiving data for a medical record, the form including at least one image data field;
receiving at the physician teleconferencing station, digital image data recorded by the camera;
selectively storing at least a portion of the digital image data received by the physician teleconferencing station in the at least one image data field; and
storing the data in the form into an electronic medical record.

22. The method of claim 21, further comprising:
providing the patient teleconferencing station with a form for entering demographic data;
transmitting entered demographic data from the patient teleconferencing station to the physician teleconferencing station; and
storing at least a portion of the transmitted demographic data in the electronic medical record.

23. The method of claim 21, further comprising:
providing the patient teleconferencing station with a form for entering medical history data;
transmitting entered medical history data to the physician teleconferencing station; and
storing at least a portion of the transmitted medical history data in the electronic medical record.

24. The method of claim 21, further comprising:
providing the physician teleconferencing station with a medial examination form for entering medical examination notes; and
storing entered medical examination notes into the electronic medical record.

25. The method of claim 24, wherein the medical examination form includes fields for entering patient chief complaint and vital signs.

26. The method of claim 25, wherein the medical examination form includes means for entering audio data.

27. The method of claim 25, further comprising means for entering medical prescription data.
